(19) United States
(12) Patent Application Publication
(10) Pub. No.: US 2016/0098142 A1
(43) Pub. Date: Apr. 7, 2016

(54) PALM GESTURE DETECTION

(71) Applicant: Microsoft Technology Licensing, LLC, Redmond, WA (US)

(72) Inventor: Amil WINEBRAND, Petach-Tikva (IL)

(21) Appl. No.: 14/877,129

(22) Filed: Oct. 7, 2015

Related U.S. Application Data
(60) Provisional application No. 62/060,582, filed on Oct. 7, 2014.

(51) Int. Cl. G06F 3/041; G06F 3/0482; G06F 3/01; G06F 3/044

(52) U.S. Cl. CPC G06F 3/0416; G06F 3/044; G06F 3/0482; G06F 3/017; G06F 2203/04111

(57) ABSTRACT

A device includes an electronic display configured to display an object, a digitizer sensor and a circuit. The digitizer sensor is integrated with the display and senses touch input from a palm. The circuit detects coordinates of the touch input, detects a contour of the touch input and selects the object based on the object being at least partially surrounded by the contour.

### RELATED APPLICATION

This application claims the benefit of priority under 35 USC §119(e) of U.S. Provisional Patent Application No. 62/060,582 filed on Oct. 7, 2014, the contents of which are incorporated herein by reference in their entirety.

### BACKGROUND

Touch enabled devices use digitizer sensors for tracking touch input. Typically, the digitizer sensor includes rows and columns of conductive material layered on an electronic visual display. A user interacts with the digitizer sensor by positioning and moving an object such as stylus and/or a finger over a sensing surface, e.g. a tablet and/or a touchscreen. Location of the object with respect to the sensing surface is tracked by circuitry associated with the digitizer sensor and interpreted as a user command. Position detection can typically be performed while the object is either touching and/or hovering over the sensing surface. Touch enabled devices that operate with digitizer sensors include mobile phones, tablets, laptops, and the like.

### SUMMARY

According to an aspect of some embodiments of the disclosure there is provided a method and system for detecting gestures performed by the palm and for operating a touch enabled device with palm gestures. According to an aspect of some embodiments of the disclosure, both shape and position of palm input is used to identify a gesture. In some exemplary embodiments, relationship between both shape and location of palm input to objects displayed on a touchscreen is detected. In some exemplary embodiments, a selection gesture is initiated when detecting partial enclosure or cupping of a palm around an item displayed on a touchscreen. In some exemplary embodiments, an erase gesture is initiated when a palm rubbing movement is detected. Optionally, during an erase gestures objects displayed under touch imprint of the palm are erased.

Unless otherwise defined, all technical and/or scientific terms used herein have the same meaning as commonly understood by one of ordinary skill in the art. Although methods and materials similar or equivalent to those described herein can be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the disclosure are herein described, by way of example only, with reference to the accompanying drawings. With specific reference now to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

In the drawings:

FIGS. 1A and 1B schematically illustrate an exemplary palm gesture in accordance with some embodiments of the present disclosure;

FIGS. 2A and 2B schematically illustrate an exemplary palm gesture performed with two hands in accordance with some embodiments of the present disclosure;

FIGS. 3A and 3B schematically illustrate an exemplary displacement gesture performed with palm input in accordance with some embodiments of the present disclosure;

FIGS. 4A and 4B schematically illustrate an exemplary erase gesture performed with palm input in accordance with some embodiments of the present disclosure;

FIG. 5 schematically illustrates an exemplary touchscreen that detects a palm gesture and displaying a selection menu in accordance with some embodiments of the present disclosure;

FIG. 6 is a simplified flow chart describing an exemplary method for detecting a gesture performed with a palm in accordance with some embodiments of the present disclosure;

FIG. 7A schematically illustrates exemplary touch input in accordance with some embodiments of the present disclosure;

FIGS. 7B and 7C are simplified representations of two exemplary methods for characterizing contour of a touch area, in accordance with some embodiments of the present disclosure;

FIG. 8 is a simplified flow chart describing an exemplary method for characterizing contour of a touch area in accordance with some embodiments of the present disclosure; and

FIG. 9 is a simplified block diagram of an exemplary digitizer system of a touch enabled device in accordance with some embodiments of the present disclosure.

### DETAILED DESCRIPTION

According to some embodiments of the present disclosure, there is provided a system and method for performing gestures on a touch-screen with a palm. According to some embodiments of the present disclosure, both the shape and location of input provided by the palm is detected and used to recognize the gesture. In some exemplary embodiments, a palm gesture includes cupping a hand around one or more objects displayed on a touch screen to select the object. According to some embodiments of the present disclosure, ‘C’ shaped contour of palm input is identified and objects displayed in on the touchscreen that are partially surrounded by the ‘C’ shaped contour are selected. In some exemplary embodiments, a displacement gestures includes sweeping the cupped shaped hand across the touchscreen to move objects that have been selected by cupping them with a hand. The objects are move together with the concave contour of the palm input. In some exemplary embodiments, an eraser gestures includes rubbing a palm on the touch screen. An area rubbed by the palm imprint is erased.

According to some embodiments of the present disclosure, both location of palm input and parameters defining a contour of the palm input are reported to a processor for identifying or executing a palm gesture. In some exemplary embodiments, the contour is defined by the outer most junctions of a palm input area.

In some exemplary embodiments, the contour is defined as a contour that surrounds a plurality of discrete palm input areas. Optionally, both location of finger input and parameters defining a contour of the finger input are reported to a processor for identifying or executing a palm gesture.

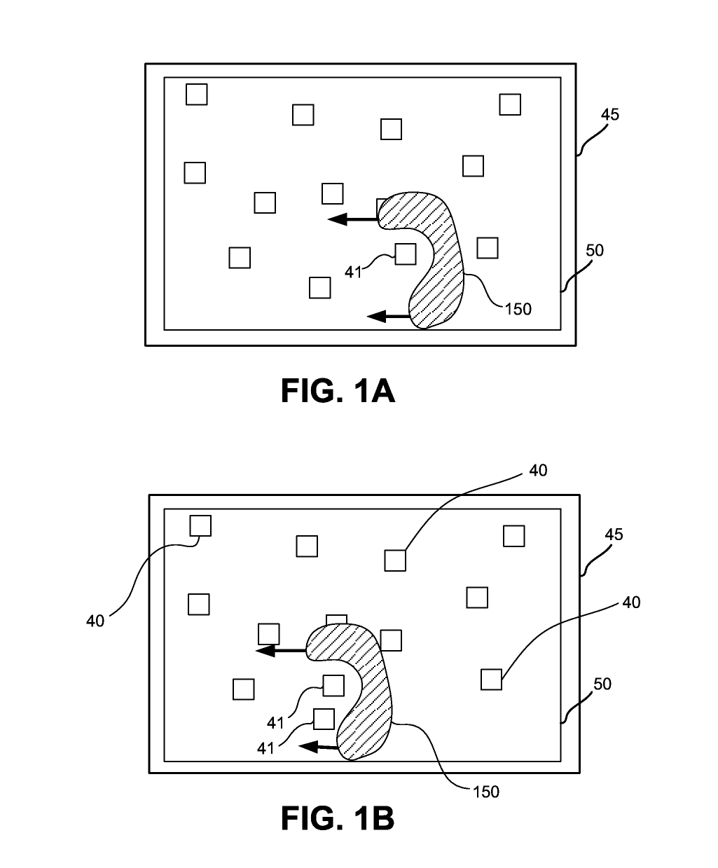

Reference is now made to FIGS. 1A and 1B schematically illustrating an exemplary palm gesture in accordance with some embodiments of the present disclosure. According to some embodiments of the present disclosure, a palm is used for performing gestures that can be recognized by a digitizer system. According to some embodiments, a digitizer sensor 50 detects palm input 150 on a touchscreen 45 and relates a position and shape of palm input 150 to location of objects 40 and 41 displayed on touchscreen 45. In some exemplary embodiments, an object 41 cupped by a hand is selected. A concave contour of palm input 150 at least partially encompassing object 141 initiates selecting of object 41. Optionally, once object 41 is selected, object 41 moves together with a hand providing palm input 150. Optionally, lifting or removing of the hand ends the gesture. Optionally, a gesture is defined such that as palm input 150 advances across touchscreen 45, additional objects 40 that are cupped by palm input 150 may be selected and moved.

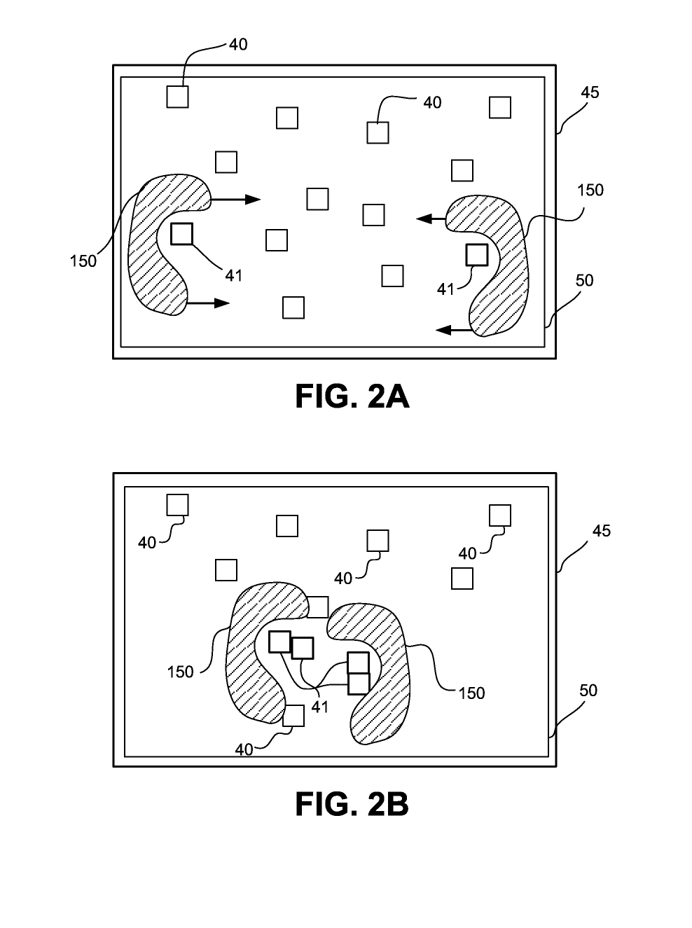

Reference is now made to FIGS. 2A and 2B schematically illustrating an exemplary palm gesture performed with two hands in accordance with some embodiments of the present disclosure. FIG. 2A shows exemplary palm inputs 150 at a start of the gesture and FIG. 2B shows position of palm inputs and selected objects at the termination of the gesture. The arrows in FIG. 2A, show a general direction of movement during the gesture.

In some exemplary embodiments, two hands cupped over display 45 move toward each other and gather virtual objects 41. Objects 41 are identified based on their relative position with respect to a concave contour of each of palm inputs 150. Palm inputs 150 are representative touch imprints obtained from a hand cupped over display 45. Palm gestures as described herein may be used for gross manipulation of virtual objects displayed on display 45. A relative large number of objects may be quickly manipulated over display 45 by sweeping a hand across display 45. Gross manipulation can also be combined with finer manipulation of individual objects using a fingertip to select and move an object.

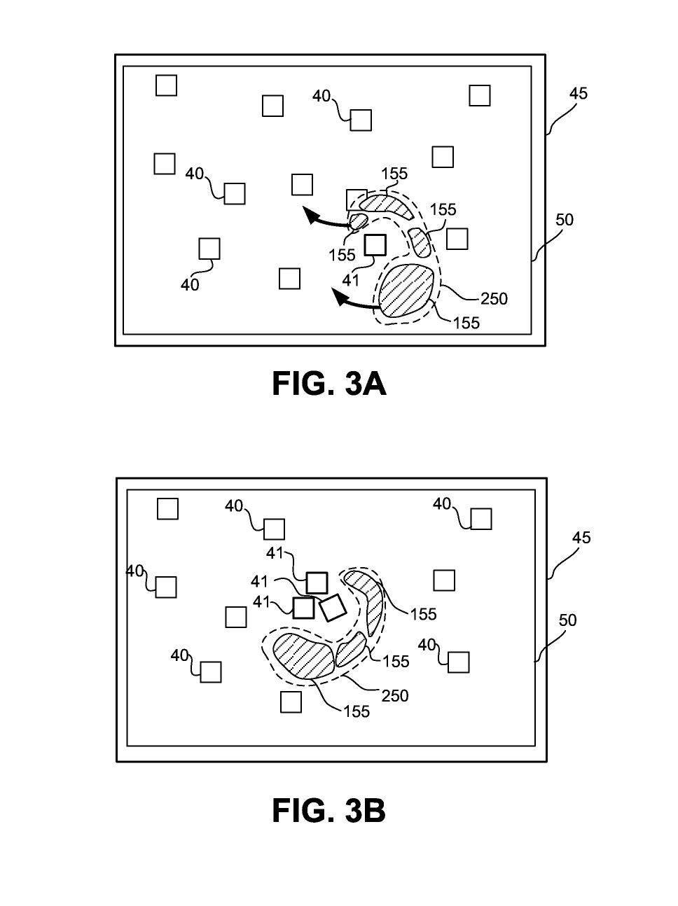

Reference is now made to FIGS. 3A and 3B schematically illustrating an exemplary displacement gesture performed with palm input in accordance with some embodiments of the present disclosure. FIG. 3A shows exemplary discrete areas 155 of palm inputs at a start of the gesture and FIG. 3B shows exemplary discrete areas 155 at the termination of the gesture. The arrows in FIG. 3A, show a general direction of movement during the gesture.

At times, a palm imprint on digitizer sensor 50 includes a plurality of discrete areas 155. Although each of discrete areas 155 do not independently define a concave contour, a collective area covered by the plurality of discrete areas 155 may outline a concave shape defining the cupped shape of the hand providing the palm input.

According to some embodiments of the present disclosure, cupping of a hand around an object 41 displayed on screen 45 can be detected by defining a contour 250 that follows and encompasses the plurality of discrete areas 155. Based on contour 250, selection of objects 41 by cupping a hand around objects 41 can be identified. Contour 250 is typically updated during movement of the hand to match newly detected discrete areas 155. As the hand moves across display 45, discrete areas 155 detected by digitizer sensor 50 may change due to a change in posture of the hand. For example, the discrete areas 155 in FIG. 3A are different in both number and shape as compared to discrete areas 155 in FIG. 3B.

In some exemplary embodiments, during the displacement gesture, objects 41 selected based on palm input move together with movement of the hand. Optionally, orientation of objects 41 also follows a change in orientation of the hand performing the gesture. For example, one of objects 41 is rotated in a clockwise direction following rotation of contour 250.

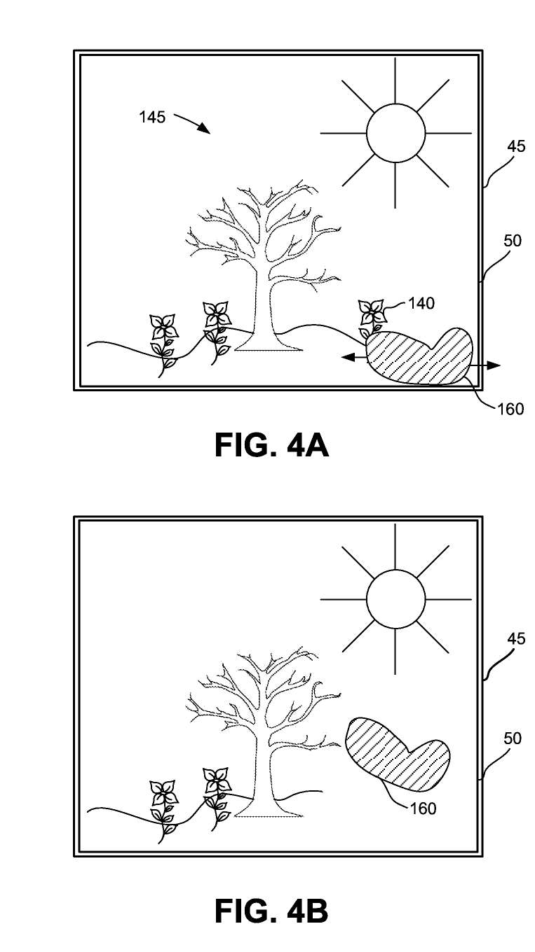

Reference is now made to FIGS. 4A and 4B schematically illustrating an exemplary erase gesture performed with palm input in accordance with some embodiments of the present disclosure. FIG. 4A shows a displayed image and palm input at a start of the gesture and FIG. 4B shows the displayed image and palm input at end of the gesture. According to some embodiments of the present disclosure, palm input is used to perform an erase gesture for removing portions of what is displayed on display 45. In some exemplary embodiments, a palm imprint 160 on digitizer sensor 50 defines an area that is to be erased. Optionally, an eraser gesture is recognized by back and forth motion of a palm across a screen similar to the motion typically used when erasing with a pencil eraser. Different areas can be erased by moving the palm in a particular direction while continuing with the back and forth movement.

Optionally, portions of an image 140 or objects, e.g. object 40 in FIGS. 1A and 1B covered by palm imprint 160 are erased. Palm imprint 160 is an area of palm input as detected by digitizer sensor 50. Optionally, palm imprint 160 may be contour defined to encompass a plurality of discrete areas of palm imprint.

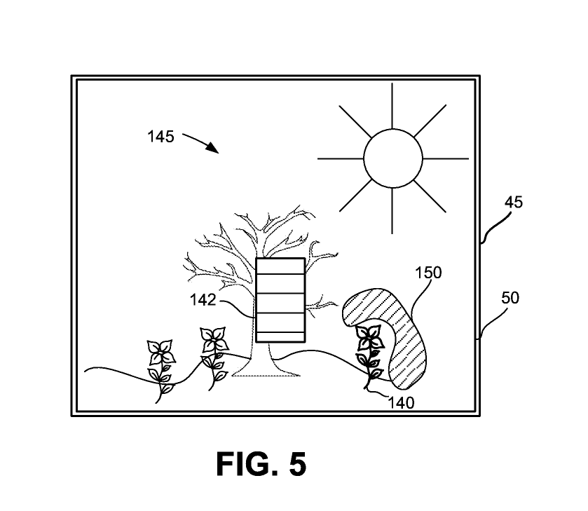

Reference is now made to FIG. 5 schematically illustrating an exemplary touchscreen that detects a palm gesture and displaying a selection menu in accordance with some embodiments of the present disclosure. According to some embodiments of the present disclosure, once an object 140 is selected based on palm input 150 a menu 142 is displayed providing a selection of actions that can be performed on selected object 140. In some exemplary embodiments, menu 142 is displayed at a defined convenient location with respect to palm input area 150. For example, menu 142 is displaced from palm input 150 so that a user's hand does not obstruct menu 142. In an additional example, contour of palm input 150 is detected to determine if the right or left hand was used to provide input 150 and menu 142 is positioned at a location conveniently accessible by the opposite hand. Typically, menu 142 is positioned on the side facing the concave portion of input 150.

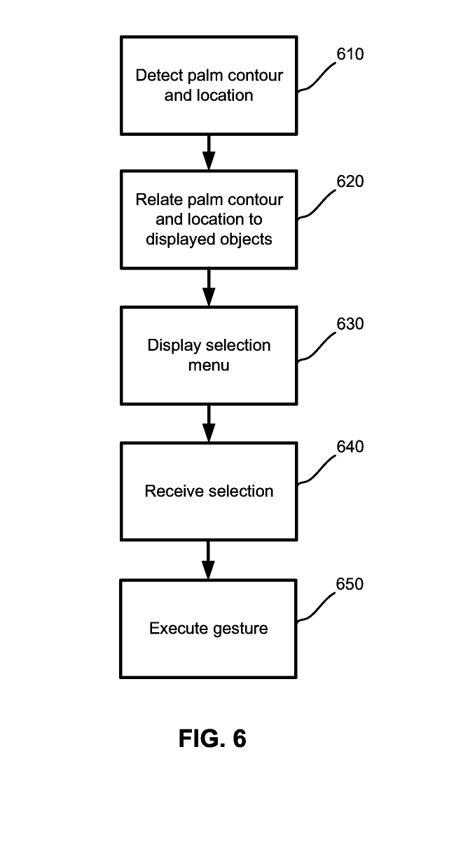

Reference is now made to FIG. 6 showing a simplified flow chart describing an exemplary method for detecting a gesture performed with a palm in accordance with some embodiments of the present disclosure. According to some embodiments of the present disclosure, one or more gestures to a digitizer sensor are performed with a hand input as opposed to fingertip input. According to some embodiments, both contour and location of palm input during the gesture is detected and tracked (block 610). Optionally, location of the palm input is defined by coordinates of a center of a palm input area or a center of mass of a palm input area. In some exemplary embodiments, contour of palm input is defined by parametric function as is described in more detail herein. In some exemplary embodiments, a contour defining a cupping shape of a palm imprint is detected and tracked.

According to some embodiments, an object displayed on the screen is selected based on its position relative to the location and contour of the palm input (block 620).

In some exemplary embodiments, an object that is partially surrounded by a palm imprint is selected. For example, an object that is proximal to a concave portion of the contour of a palm imprint is selected while an object that is proximal to a convex portion of the contour is not selected.

According to some embodiments, the gesture is a displacement gesture and movement of the palm is followed by movement of the selected object. Typically, the object moves so that it maintains its relative position with respect to the contour of the palm input. Optionally, the object also rotates in response to rotation of the hand performing the gesture.

Optionally, in response to selection of an object based on palm input, a menu is displayed on the screen (block 630). Typically, the menu is displayed at the termination of the gesture. Optionally, the menu is displayed on a portion of the screen that is not blocked by palm input. In some embodiments, the menu is displayed on concave side of the contour so that it can be easily reached by the free hand not being used to provide the palm gesture. Typically, selection of an item on the menu is based on fingertip touch. The selection is received (block 640) and the command is executed on the item selected by palm input (block 650). An exemplary command may be a command to alter an appearance of an object selected, alter a font of a selected word or can be other commands.

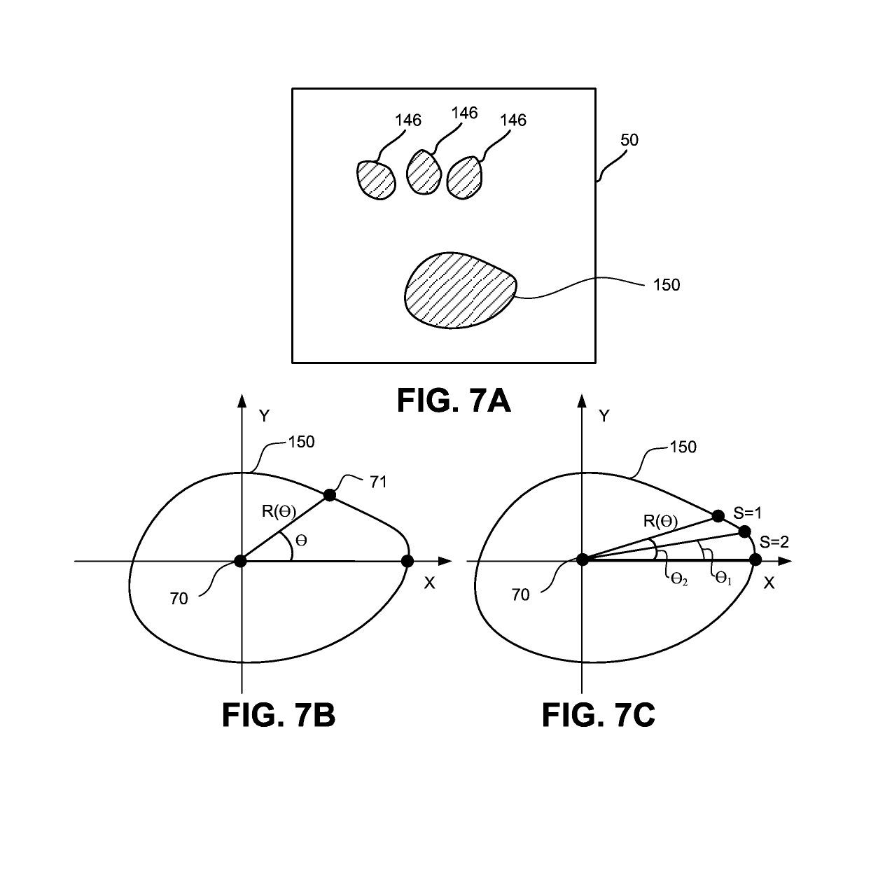

Reference is now made to FIG. 7A schematically illustrating exemplary touch input in accordance with some embodiments of the present disclosure. Four exemplary touch imprints are shown. Imprints 204, 208 and 212 are exemplary imprints of fingertip input and imprint 150 is an exemplary imprint of palm input. Typically, the imprints are defined by a plurality of junctions of a grid based capacitive sensor that senses input from the hand. Preprocessing may be performed on the output detected from digitizer sensor 50, for example to remove noise outside an expected range of frequencies for detecting fingertip touch and/or stylus touch. A contour for each of the imprints may be defined and used to define or recognize a gesture performed by the hand. In some embodiments, a contour is represented as a parametric function (x(t), y(t)) for a variable t changing for example, between 0 and 1. Since t is monotonously increasing, both x(t) and y(t) are functions.

Reference is now made to FIGS. 7B and 7C showing simplified representations of two exemplary methods for characterizing contour of a touch area, in accordance with some embodiments of the present disclosure. In some exemplary embodiments, a contour is represented as (θ, r(θ)) as measured for example from a center of mass of the touch area 70, from a point internal to the contour, or the like, as shown for example in FIG. 7B. In this embodiment, θ is an angle measured between the positive part of the X axis and a segment connecting the point 70 within the contour to a point 71 on the contour, and R(θ) is the segment length. If the touch area is concave, then one or more angles θ may be associated with a multiplicity of r(θ) values. In such case, the one of these values can be selected, for example the largest in order to include more information. The (θ, r(θ)) sequence thus represents a function.

In further embodiment, each point in a contour may be represented as (s, θ), wherein s is an accumulated length along the contour (which may be segment-wise rather than continuous, especially due to the discrete manner in which the information is obtained)), and θ is an angle associated with each such length or segment, as shown in FIG. 7C. Since s is monotonously increasing, the (s, θ) sequence thus also represents a function.

Optionally, the contour function is coded, e.g. using Fast Fourier Transform (FFT) and one or parameters of the code are reported along with coordinates of touch input to a host computer associated with digitizer sensor 50, a processor and/or an application running a the host. Optionally, only the first 3-5 coefficients of the FFT functions is reported for characterizing the contour.

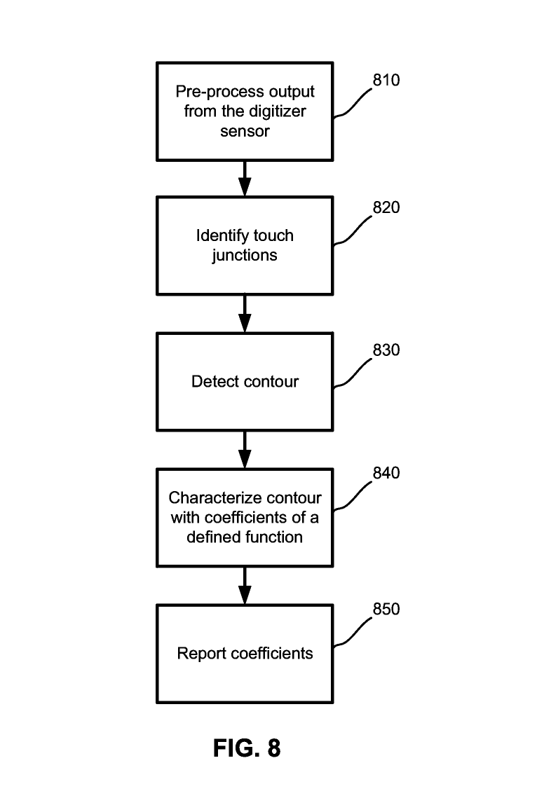

Reference is now made to FIG. 8 showing a simplified flow chart describing an exemplary method for characterizing contour of a touch area in accordance with some embodiments of the present disclosure. According to some embodiments of the present disclosure, output from the digitizer sensor is pre-processed (block 810) and junctions indicating touch are identified based on the pre-processed output (block 820). A contour surrounding the detected junctions is defined (block 830).

Optionally, the contour includes a plurality of discrete areas of including palm input separated by areas or junctions with no palm input as described, for example in reference to FIGS. 3A and 3B. According to some embodiments, the function is defined for characterizing the contour (block 840) and a plurality of coefficients of the functions is reported to a processor, e.g. a host computer (block 850).

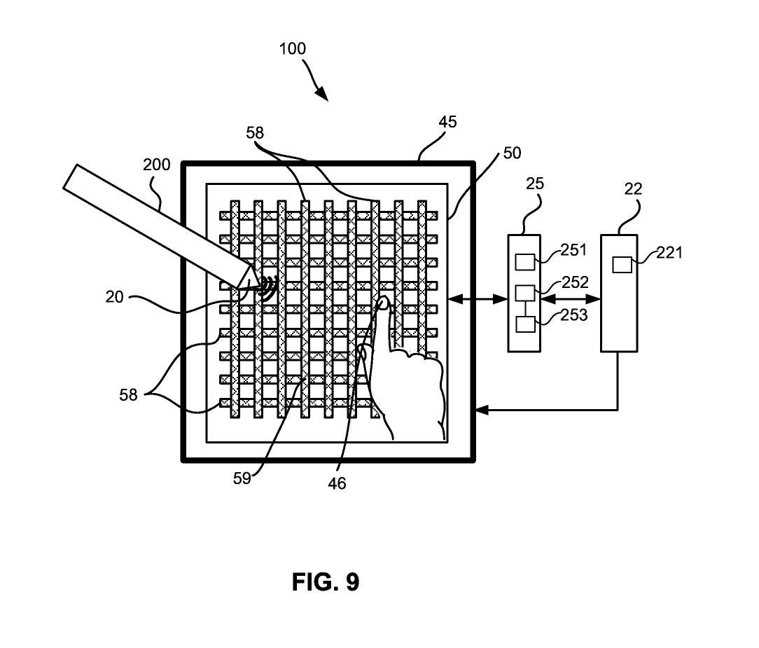

Reference is now made to FIG. 9 showing a simplified block diagram of an exemplary digitizer system of a touch enabled device in accordance with some embodiments of the present disclosure. According to some embodiments of the present disclosure, a computing device 100 includes a display screen 45 that is integrated with a digitizer sensor 50. Digitizer sensor 50 is operated and sampled by digitizer circuitry 25 and output from digitizer circuitry 25 is reported to host 22.

In some exemplary embodiments, digitizer sensor 50 is a grid based capacitive sensor formed with row and column conductive strips 58. Typically, conductive strips 58 are electrically insulated from one another and each of conductive strips is connected at least on one end to digitizer circuitry 25. Typically, conductive strips 58 are arranged to enhance capacitive coupling between row and column conductive lines, e.g. around junctions 59 formed between rows and columns in response to presence of a conductive object.

According to some embodiments of the present disclosure, conductive strips 58 are operative to detect input by touch of one or more fingertips 46, palm or other conductive objects and/or a stylus 200 transmitting an electromagnetic signal. Digitizer circuitry 25 typically includes dedicated circuitry 251 for detecting signals emitted by stylus 200, dedicated circuitry 252 for detecting coordinates of input from fingertip 46 and palm input, and dedicated circuitry 253 for further characterizing palm input.

Optionally, a mutual capacitance detection method and/or a self-capacitance detection method are applied on sensor 50 for sensing interaction with hand input such as fingertip 46. Typically, during mutual capacitance and self-capacitance detection, digitizer circuitry 25 sends a triggering pulse and/or interrogation signal to one or more conductive strips 58 of digitizer sensor 50 and samples output from crossing conductive strips 58 in response to the triggering and/or interrogation. In some embodiments, some or all of conductive strips 58 along one axis of the grid based sensor are interrogated simultaneously or in a consecutive manner, and in response to each interrogation, outputs from conductive strips 58 on the other axis are sampled. This scanning procedure provides for obtaining output associated with each junction 59 of the grid based sensor 50. Typically, this procedure provides for detecting coordinates one or more conductive objects, e.g. fingertip 46 touching and/or hovering over sensor 50 at the same time (multi-touch). According to some embodiments of the present disclosure, finger detection circuitry 252 for manages the triggering pulse and/or interrogation signal, processes input from one or more fingertips 46 and detects coordinates of one or more fingertips 46 of palms touch digitizer sensor 50.

Optionally, digitizer circuitry additionally includes dedicated palm detection circuitry 253 for processing input from palm, e.g. parts of the hand other than fingertip 46. In some exemplary embodiments, a contour of palm input is characterized by circuitry 253.

Typically, the output provided by digitizer circuitry 25 may include one or more of coordinates of writing tip 20 of stylus 200, coordinates of one or more fingertips 46, coordinates of palm input, and parameters characterizing a contour of palm input. Typically, digitizer circuitry 25 uses both analog and digital processing to process signals detected with digitizer sensor 50. Optionally, some and/or all of the functionalities of dedicated circuitry 251, 252 and 253 are integrated in one or more processing units adapted for controlling operation of digitizer sensor 50. Optionally, some and/or all of the functionalities of digitizer circuitry 25, dedicated circuitry 251, 252 and 253 are integrated and/or included in host 22. According to some embodiments of the present disclosure, one or more applications 221 running on host 22 control and/or manage communication between digitizer sensor 50 and the other computing device when present.

According to an aspect of some embodiments there is provided a device comprising: an electronic display configured to display an object; a digitizer sensor configured to sense touch input from a palm, wherein the digitizer sensor is integrated with the display, and a circuit configured to: detect coordinates of the touch input; detect a contour of the touch input; and select the object based on the object being at least partially surrounded by the contour.

Optionally, the circuit is configured to define the contour with a plurality of coefficients of a pre-defined function.

Optionally, the function is a segmented differential function.

Optionally, the function is a parametric function.

Optionally, the coefficients are FFT coefficients of the pre-defined function.

Optionally, the device includes a host computer; and an application running on the host computer, wherein the plurality of coefficients is reported to the application.

Optionally, the circuit is configured to track changes in the coordinates of the touch input and in the contour as a palm sweeps across the display and to adjust position of the object according to the changes.

Optionally, the circuit is configured to display a menu based on the object being selected, wherein the menu is displayed at a defined location with respect to a concave portion of the contour.

Optionally, the digitizer sensor is a grid based capacitive sensor.

Optionally, the digitizer sensor includes a plurality of row conductive lines crossing and a plurality of column conductive lines defining junctions at the crossings, wherein the touch input is detected on a plurality of the junctions.

According to an aspect of some embodiments there is provided a device including an electronic display configured to display an object; a digitizer sensor configured to sense touch input from a palm, wherein the digitizer sensor is integrated with the display, and a circuit configured to: detect coordinates of the touch input; detect a contour of the touch input; detect back and forth motion of the contour; and erase the object or a portion thereof from the display based overlap between area enclosed by the contour and the object or the portion.

Optionally, the circuit is configured to define the contour with a plurality of coefficients of a pre-defined function.

According to an aspect of some embodiments there is provided a method comprising: displaying an object on a display; sensing touch input from a palm with a digitizer sensor, wherein the digitizer sensor is integrated with the display; detecting coordinates of the touch input; detecting a contour of the touch input; and selecting the object based on the object being at least partially surrounded by the contour.

Optionally, the method includes defining the contour with a plurality of coefficients of a pre-defined function.

Optionally, the function is a segmented differential function.

Optionally, the function is a parametric function.

Optionally, the coefficients are FFT coefficients of the pre-defined function.

Optionally, the method includes reporting the plurality of coefficients to a host computer associated with the display.

Optionally, the method includes tracking changes in the coordinates of the touch input and in the contour as a palm sweeps across the display and adjusting position of the object according to the changes.

Optionally, the method includes displaying a menu based on the object being selected, wherein the menu is displayed at a defined location with respect to a concave portion of the contour.

Certain features of the examples described herein, which are, for clarity, described in the context of separate embodiments, may also be provided in combination in a single embodiment. Conversely, various features of the examples described herein, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

What is claimed is:

1. A device comprising:
an electronic display configured to display an object;
a digitizer sensor configured to sense touch input from a palm, wherein the digitizer sensor is integrated with the display, and
a circuit configured to:
detect coordinates of the touch input;
detect a contour of the touch input; and
select the object based on the object being at least partially surrounded by the contour.

2. The device of claim 1, wherein the circuit is configured to define the contour with a plurality of coefficients of a pre-defined function.

3. The device of claim 2, wherein the function is a segmented differential function.

4. The device of claim 2, wherein the function is a parametric function.

5. The device of claim 2, wherein the coefficients are FFT coefficients of the pre-defined function.

6. The device of claim 2, comprising a host computer; and an application running on the host computer, wherein the plurality of coefficients is reported to the application.

7. The device of claim 1, wherein the circuit is configured to track changes in the coordinates of the touch input and in the contour as a palm sweeps across the display and to adjust position of the object according to the changes.

8. The device of claim 1, wherein the circuit is configured to display a menu based on the object being selected, wherein the menu is displayed at a defined location with respect to a concave portion of the contour.

9. The device of claim 1, wherein the digitizer sensor is a grid based capacitive sensor.

10. The device of claim 9, wherein the digitizer sensor includes a plurality of row conductive lines crossing and a plurality of column conductive lines defining junctions at the crossings, wherein the touch input is detected on a plurality of the junctions.

11. A device comprising:
an electronic display configured to display an object;
a digitizer sensor configured to sense touch input from a palm, wherein the digitizer sensor is integrated with the display, and
a circuit configured to:
detect coordinates of the touch input;
detect a contour of the touch input;
detect back and forth motion of the contour; and
erase the object or a portion thereof from the display based overlap between area enclosed by the contour and the object or the portion.

12. The device of claim 11, wherein the circuit is configured to define the contour with a plurality of coefficients of a pre-defined function.

13. A method comprising:
displaying an object on a display;
sensing touch input from a palm with a digitizer sensor, wherein the digitizer sensor is integrated with the display;
detecting coordinates of the touch input;
detecting a contour of the touch input; and
selecting the object based on the object being at least partially surrounded by the contour.

14. The method of claim 13, comprising defining the contour with a plurality of coefficients of a pre-defined function.

15. The method of claim 14, wherein the function is a segmented differential function.

16. The method of claim 14, wherein the function is a parametric function.

17. The method of claim 14, wherein the coefficients are FFT coefficients of the pre-defined function.

18. The method of claim 14, comprising reporting the plurality of coefficients to a host computer associated with the display.

19. The method of claim 13, comprising tracking changes in the coordinates of the touch input and in the contour as a palm sweeps across the display and adjusting position of the object according to the changes.

20. The method of claim 13, comprising displaying a menu based on the object being selected, wherein the menu is displayed at a defined location with respect to a concave portion of the contour.
